(19) United States
(12) Patent Application Publication
(10) Pub. No.: US 2018/0343460 A1
(43) Pub. Date: Nov. 29, 2018

(54) DECODER RESOURCE ALLOCATING METHOD AND ASSOCIATED APPARATUS

(71) Applicant: MediaTek Singapore Pte. Ltd., Singapore (SG)

(72) Inventor: Xiaoyong Lu, Hefei, Anhui (CN)

(21) Appl. No.: 15/986,835

(22) Filed: May 23, 2018

(30) Foreign Application Priority Data
May 27, 2017 (CN) 201710388113.7

(51) Int. Cl. H04N 19/44

(52) U.S. Cl. CPC H04N 19/44

(57) ABSTRACT

A decoder resource allocating method includes: recording a total resource occupied percentage of each decoder occupied by video which are playing; acquiring a decoder selecting method, a decoding type, and a required decoder resource of a current path video; and looking up a decoder performance parameter table according to the total resource occupied percentage of each decoder, the decoder selecting method, the decoding type, and the required decoder resource to select a suitable decoder resource. A corresponding decoder resource allocating apparatus is also provided. The present invention can flexibly select a decoder according to the play requirement and the available resource of the decoders to secure the success rate of playing and implement multi-path play for signal decoder to elevate the resource utilizing rate of the decoder and lower the manufacturing cost.

### BACKGROUND

The present invention relates to the field of video technology, and more particularly, to a decoder resource allocating method and an associated apparatus.

Conventionally, playback of video requires decoders to decode a digital video data stream/file and turn it into a simulation video signal. The decoders can be categorized into hardware decoders and software decoders, wherein during playback, the hardware decoder consumes its own resources, which limits its effectiveness.

The limited resources of the hardware decoder restrict its ability to meet the growing needs of multi-path video play. Conventional hardware decoders only support single path video play to avoid making mistakes. Therefore, multiple hardware decoders are required to enable multi-path video play, meaning the resources of the hardware decoder are not effectively and thoroughly used, which increases the cost of multi-path video play.

### SUMMARY

The embodiments of the present invention provide a decoder resource allocating method and an associated apparatus to solve the prior art problem of decoder resources not being effectively used during multi-path video play.

A scheme used by the present invention is to provide a decoder resource allocating method, comprising: recording a total resource occupied percentage of each decoder occupied by videos which are playing; acquiring a decoder selecting method, a decoding type, and a required decoder resource of a current path video; and looking up a decoder performance parameter table according to the total resource occupied percentage of each decoder, the decoder selecting method, the decoding type, and the required decoder resource in order to select a suitable decoder resource.

In one embodiment, the decoder selecting method includes at least one of a number of decoders simultaneously being used and priority information of the decoders being used.

In one embodiment, the decoder performance parameter table includes maximum frames per second (FPS) supported by different decoder types and different resolutions under different decoder selecting methods, wherein the different decoder types and the different resolutions are obtained according to the ability of each decoder.

In one embodiment, the steps of looking up the decoder performance parameter table according to the total resource occupied percentage of each decoder, the decoder selecting method, the decoding type, and the required decoder resource to select the suitable decoder resource includes: selecting decoders from candidate decoders according to the decoding type and the decoder selecting method; calculating an estimated resource occupied percentage for the selected decoders according to the total resource occupied percentage of the selected decoders as well as the decoder resource required for playing the current path video, in which the estimated resource occupied percentage is a sum of the total resource occupied percentage of the selected decoders and the percentage of the decoder resource required for playing the current path video over the total resource percentage of the selected decoders; determining if the selected decoders are able to support the current path video according to the estimated resource occupied percentage; when it is determined they can support the current path video, using the selected decoder for playing the current path video and updating the total resource occupied percentage of the selected decoder; when it is determined they cannot support the current path video, removing the selected decoder from the candidate decoders without using the selected decoder to play the current path video to update the candidate decoders; and the abovementioned steps are iteratively performed.

In one embodiment, the steps of determining if the selected decoders are able to support the current path video according to the estimated resource occupied percentage comprises: determining if the estimated resource occupied percentage is greater than a predetermined value; if the estimated resource occupied percentage is greater than the predetermined value, determining the selected decoder is not able to support the current path video; and if the estimated resource occupied percentage is smaller than or equal to the predetermined value, determining the selected decoders are able to support the current path video.

In one embodiment, the steps of determining if the selected decoders are able to support the current path video according to the estimated resource occupied percentage comprises: determining if the estimated resource occupied percentage is greater than a predetermined value; if the estimated resource occupied percentage is smaller than or equal to the predetermined value, determining the selected decoders are able to support the current path video; if the estimated resource occupied percentage is greater than the predetermined value, determining if there are any low priority videos; when there are no low priority videos, determining the selected decoders are not able to support the current path video; when there are low priority videos, sequentially stopping the low priority videos following an order from low priority to high priority and releasing the occupied decoder resources, and determining if the estimated resource occupied percentage after release is smaller than or equal to the predetermined value; if yes, determining the selected decoders are able to support the current path video; and if no, continuing to stop the low priority videos sequentially following the order from low priority to high priority and releasing the resources, and determining the selected decoders are not able to support the current path video when all the low priority videos are stopped and the estimated resource occupied percentage after release is greater than the predetermined value.

In one embodiment, after all low priority videos are stopped and the estimated resource occupied percentage after release is greater than the predetermined value, the steps further comprise: resuming playing low priority videos.

In one embodiment, the steps of determining if the selected decoders are able to support the current path video according to the estimated resource occupied percentage comprises: determining if the estimated resource occupied percentage is greater than a predetermined value; if the estimated resource occupied percentage is smaller than or equal to the predetermined value, determining the selected decoders are able to support the current path video; if the estimated resource occupied percentage is greater than the predetermined value, determining if there are any low priority videos; if there are no low priority videos, determining the selected decoders are not able to support the current path video; if there are low priority videos, releasing the decoder resources occupied by the low priority videos and determining if the estimated resource occupied percentage is greater than the predetermined percentage after release; if yes, determining the selected decoders are not able to support the current path video; and if no, determining the selected decoders are able to support the current path video, and sequentially stopping videos following an order from low priority to high priority and releasing the occupied decoder resource until the estimated resource occupied percentage after release is smaller than or equal to the predetermined value.

Another scheme used by the present invention is to provide a decoder resource allocating apparatus, comprising: a recording module, arranged to record a total resource occupied percentage of each decoder occupied by videos which are playing; an information acquiring module, arranged to acquire a decoder selecting method, a decoding type, and a required decoder resource of a current path video; and a resource allocating module, arranged to look into a decoder performance parameter table according to the total resource occupied percentage of each decoder, the decoder selecting method, the decoding type, and the required decoder resource in order to select a suitable decoder resource.

In one embodiment, the decoder selecting method comprises at least one of a number of decoders simultaneously being used and priority information of the decoders being used.

In one embodiment, the decoder performance parameter table lists maximum frame rates supported by different decoding types and different resolutions under different decoder selecting methods according to the decoding ability of each decoder.

One of the advantages of the present invention is: by looking up the decoder performance parameter table according to the resource occupied percentage of each decoder, the decoder selecting method, the decoding type and the required decoder resource of the current path video to select the suitable decoder resource, decoders can be flexibly selected according to the playing requirement of videos and the available resource of the decoders to secure the success rate of playing videos and implement multi-path play for a single decoder while elevating the resource utilizing rate for the decoders and lowering the manufacturing cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a decoder resource allocating method according to a first embodiment of the present invention.

FIG. 2 is a diagram illustrating a decoder resource allocating method according to a second embodiment of the present invention.

FIG. 3 is a diagram illustrating a decoder resource allocating method according to a third embodiment of the present invention.

FIG. 4 is a diagram illustrating a decoder resource allocating method according to a fourth embodiment of the present invention.

FIG. 5 is a diagram illustrating a decoder resource allocating method according to a fifth embodiment of the present invention.

FIG. 6 is a diagram illustrating a decoder resource allocating apparatus according to a first embodiment of the present invention.

FIG. 7 is a diagram illustrating a decoder resource allocating apparatus according to a second embodiment of the present invention.

### DETAILED DESCRIPTION

The following descriptions should be read in conjunction with the figures of the embodiments of the present invention to clearly and completely interpret the technique disclosed by the present invention. Based on the embodiments of the present invention, other embodiments realized by those skilled in the art should also fall within the scope of the present invention.

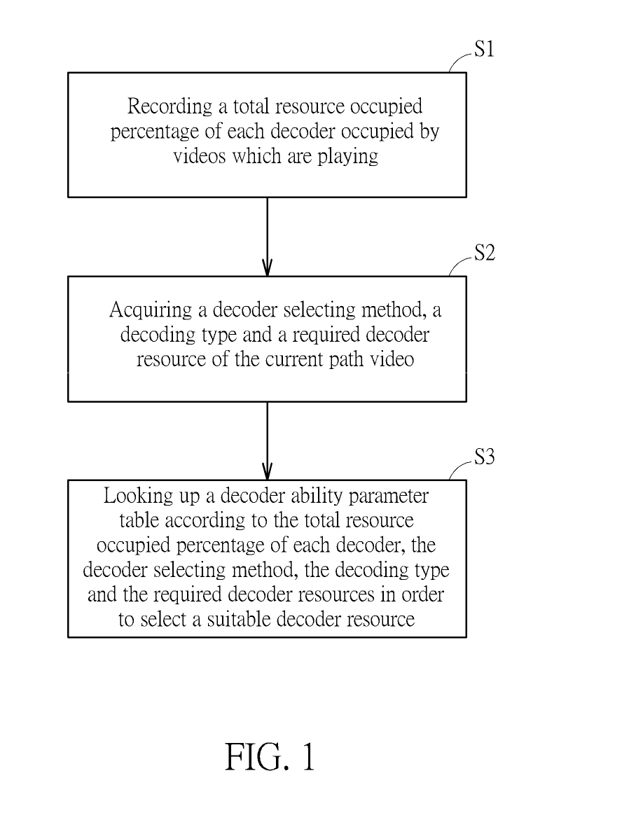

As shown in FIG. 1, a decoder resource allocating method according to a first embodiment of the present invention comprises a number of steps, which will be described herein.

S1: recording a total resource occupied percentage of each decoder occupied by videos which are playing.

The decoders in this embodiment may be hardware decoders, and the decoding ability of different decoders may be the same or different.

For each decoder, the total resource occupied percentage is a sum of the resource occupied percentage of said decoder occupied by all videos which are playing, which can reflect the available resource ratio of said decoder. The greater the total resource occupied percentage of said decoder, the smaller the available resource ratio.

Initially, when there is no video playing, the total resource occupied percentage of each decoder is zero. When the play status of videos changes, according to the percentage of a decoder resource used over the total resource of the decoder, the total resource occupied percentage of the decoder is updated. When videos are played, the percentage of playing the video over the total resource of the decoder being used is added to the original total resource occupied percentage of the decoder being used; when the video stops playing, the percentage of playing the video over the total resource of the decoder being used is subtracted from the original total resource occupied percentage of the decoder being used.

S2: acquiring a decoder selecting method, a decoding type and a required decoder resource of the current path video.

The decoder selecting method comprises at least one of a number of the decoders simultaneously being used and priority information of the decoders being used. The number of the decoders simultaneously being used is greater than zero. The priority information of the decoders being used may comprise a total number of priority and decoder labels of different priorities. When there are only two priorities, the priority information may comprise only a decoder label of priority.

The decoding type is the type of protocol standard used for decoding the current path video: for example, H263, H263, H265, MPEG4, WMV, etc. The decoder resources required for the current path video relates to the decoding type, the resolution and the FPS of the current path video. When the decoding types are identical, the higher the resolution, the more decoder resources are required; similarly, the higher the FPS, the more decoder resources are required.

S3: looking up a decoder performance parameter table according to the total resource occupied percentage of each decoder, the decoder selecting method, the decoding type and the required decoder resources in order to select a suitable decoder resource.

A decoding ability of the suitable decoder fits the requirement of the current path video and the videos which are playing to secure the accuracy of multi-path play.

The decoder performance parameter table records the decoding ability of each decoder. In one embodiment of the present invention, the decoder performance parameter table includes the maximum FPS supported by different decoding types and different resolutions under different decoder selecting methods, i.e. the maximum FPS is used to represent the decoding ability.

Through the abovementioned embodiments, looking up the decoder performance parameter table according to the total resource occupied percentage of each decoder, the decoder selecting method, the decoding type and the required decoder resources to select a suitable decoder resource can implement flexible selection of decoders according to the playing requirement of the videos and the available resource of the decoders, which can secure the success rate of playing and implement multi-path play for a single decoder while elevating the resource utilizing rate of the decoders and lowering the manufacturing cost.

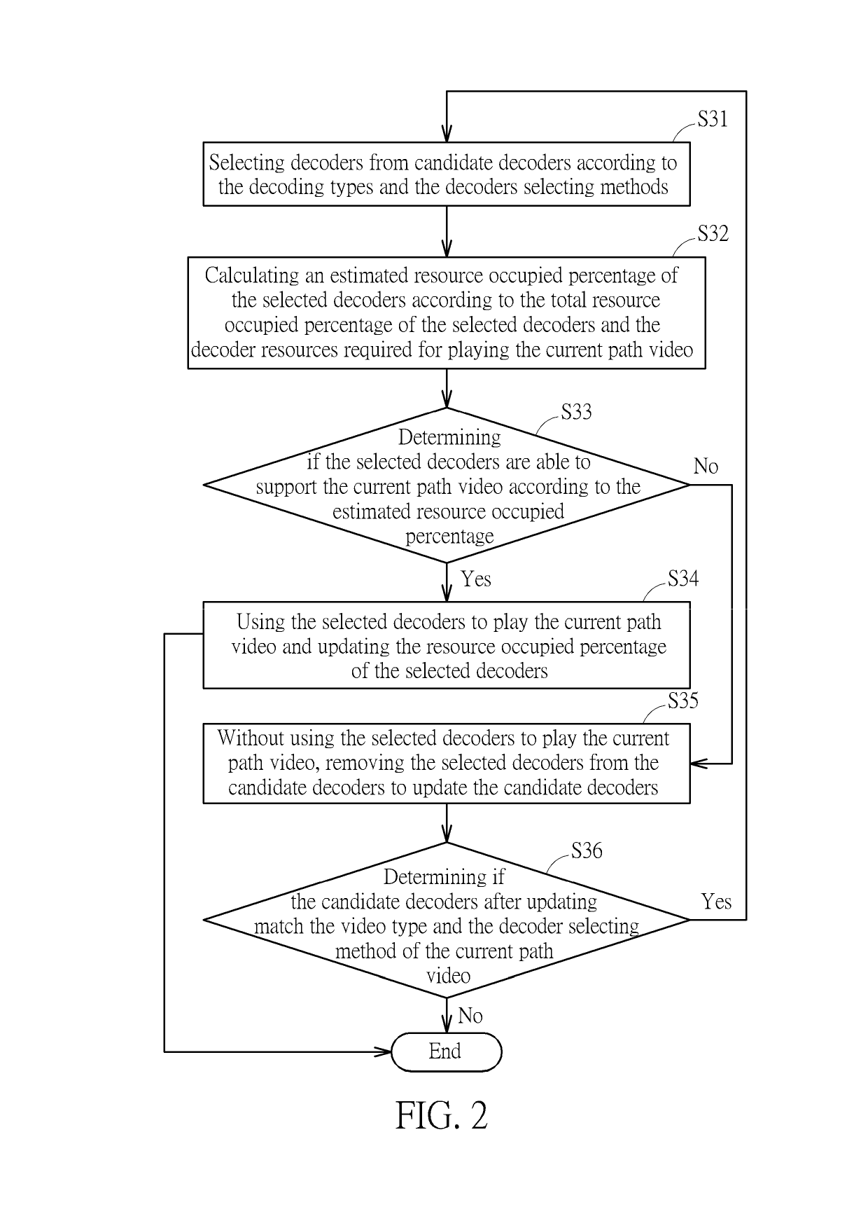

As shown in FIG. 2, a decoder resource allocating method according to a second embodiment of the present invention is based on the first embodiment of the present invention, wherein the step S3 specifically comprises:

S31: selecting decoders from candidate decoders according to the decoding types and the decoders selecting methods.

The initial candidate decoders comprise all decoders. If some decoders do not support the decoding type of the current path video, these decoders are removed to form the initial decoders.

In addition, if not taking the priority of the current path video into consideration or the priority of the current path video is the lowest, the decoders whose total resource occupied percentage equals to or greater than a predetermined value can be removed from the candidate decoders to prevent unnecessary calculation and judgment.

If the decoder selecting method comprises the number of decoders simultaneously being used, the number of the selected decoders equals to the number of the decoders simultaneously being used; if the decoder selecting method does not comprise the number of the decoders simultaneously being used, the number of the selected decoders can be a default value, such as one. If the decoder selecting method comprises the priority information of the decoders being used, the decoders with higher priority are preferably selected from the candidate decoders.

S32: calculating an estimated resource occupied percentage of the selected decoders according to the total resource occupied percentage of the selected decoders and the decoder resources required for playing the current path video.

The estimated resource occupied percentage is the sum of the total resource occupied percentage of the selected decoders and the percentage of the decoder resource required for playing the current path video over the total resource of the selected decoders. The percentage of the decoder resource required for playing the current path video over the total resource of the selected decoders can be calculated according to the decoder resource required for playing the current path video and the decoding ability of the selected decoders. If the number of selected decoders is greater than one, the decoder resource required for playing the current path video can be equally allocated to each selected decoder, or allocated to each selected decoder according to the decoding ability of the selected decoders. Other allocating methods can also be applied, and are not limited by the present invention.

If the decoder performance parameter table includes the maximum FPS supported by different decoding types and different resolutions under different decoder selecting methods, the maximum FPS can be found in the table according to the decoding type and the resolution of the current path video and the selected decoders. The percentage of the decoder resource required for playing the current path video over the total resource of the selected decoders is acquired by dividing the FPS of the current path video by the maximum FPS, and multiplying the result by 100%.

S33: determining if the selected decoders are able to support the current path video according to the estimated resource occupied percentage.

If the determination indicates that the selected decoders can support the current path video, then the selected decoders are suitable decoders and step S34 is entered; if not, the selected decoders are not suitable decoders and step S35 is entered.

The process of determining can take the priority of the current path video into consideration. A detailed description will be discussed in the following paragraphs.

S34: using the selected decoders to play the current path video and updating the resource occupied percentage of the selected decoders.

End the flow.

S35: playing the current path video without using the selected decoders, removing the selected decoders from the candidate decoders to update the candidate decoders.

S36: determining if the updated candidate decoders match the video type and the decoder selecting method of the current path video.

The updated candidate decoders which match the video type and the decoder selecting method of the current path video includes the number of decoders which support the video type among the updated candidate decoders is greater or equal to the number (which can be a default value or included in the decoder selecting method) of decoders simultaneously being used for the current path video.

If there is a match, step S31 is entered and the abovementioned steps are iteratively performed; if not, it means the decoders are not able to support playing the current path video, and the flow is ended.

Through the abovementioned embodiments, the decoder resource required for playing the current path video is normalized and calculated to get the estimated resource occupied percentage, and the determinations are done according to the estimated resource occupied percentage to simplify the calculation.

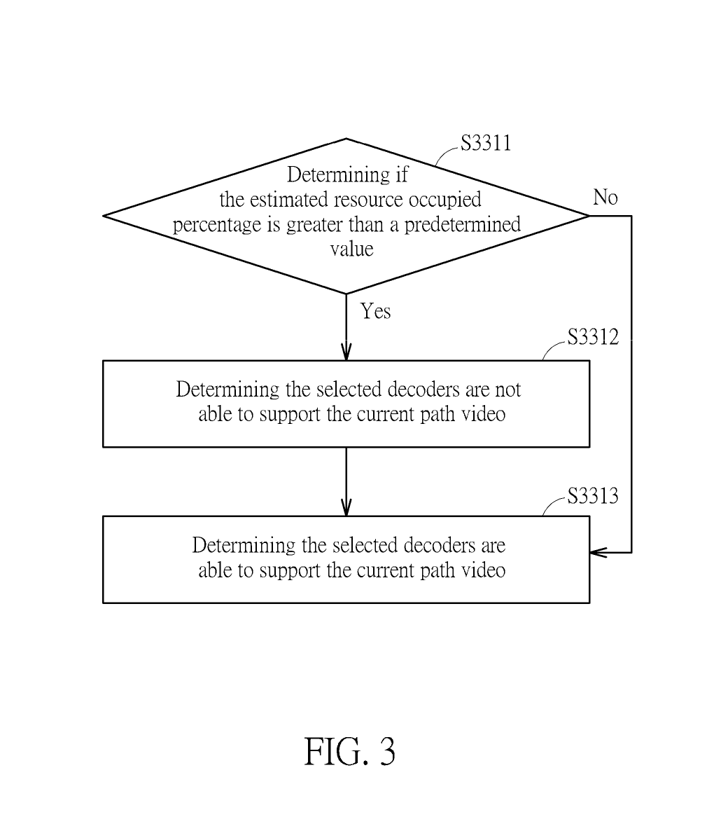

As shown in FIG. 3, a decoder resource allocating method according to a third embodiment of the present invention is based on the second embodiment of the present invention, wherein step S33 specifically comprises:

S3311: determining if the estimated resource occupied percentage is greater than a predetermined value.

The predetermined value is the maximum resource occupied percentage of the selected decoders, and is a number greater than 0% and smaller than or equal to 100%. Generally speaking, the predetermined value can be 100% or a value close to 100%.

If the estimated resource occupied percentage is greater than a predetermined value, step S3312 is entered; if not, step S3313 is entered.

S3312: determining the selected decoders are not able to support the current path video.

The following step S35 can be performed.

S3313: determining the selected decoders are able to support the current path video.

The following step S34 can be performed.

The process of determination in this embodiment does not take the priority information of the current path video into consideration, which can decrease the amount of computation.

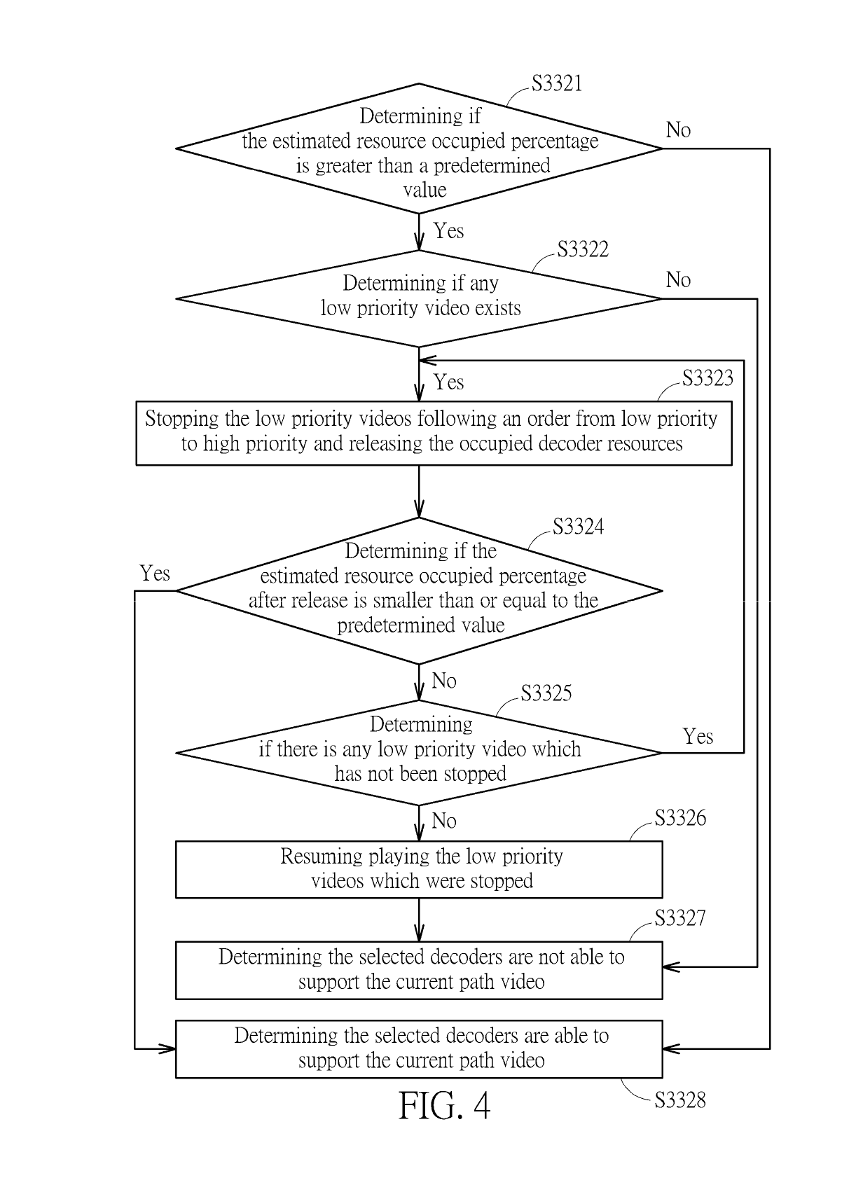

As shown in FIG. 4, a decoder resource allocating method according to a fourth embodiment of the present invention is based on the second embodiment of the present invention, wherein the step S33 specifically comprises:

S3321: determining if the estimated resource occupied percentage is greater than a predetermined value.

The predetermined value is the maximum resource occupied percentage of the selected decoders, and is a number greater than 0% and smaller than or equal to 100%. Generally speaking, the predetermined value can be 100% or a value close to 100%.

If the estimated resource occupied percentage is greater than the predetermined value, the step S3322 is entered; if not, the step S3328 is entered.

S3322: determining if any low priority video exists.

The low priority video is a video which is playing, whose priority is lower than that of the current path video, and uses the selected decoder resources.

If a low priority video exists, the step 3323 is entered; if not, the step 3327 is entered.

S3323: stopping the low priority videos following an order from low priority to high priority and releasing the occupied decoder resources.

The estimated resource occupied percentage after release is calculated according to decoder resources occupied by the low priority videos which are stopped.

S3324: determining if the estimated resource occupied percentage after release is smaller than or equal to the predetermined value.

If yes, the step S3328 is entered; if not, the step S3325 is entered.

S3325: determining if there is any more low priority video which has not been stopped.

If yes, the step 3323 is entered, and the abovementioned steps are iteratively performed; if not, this means all low priority videos are stopped and the estimated resource occupied percentage after release is still greater than the predetermined value. The step S3326 is entered.

S3326: resuming playing the low priority videos which were stopped.

S3327: determining the selected decoders are not able to support the current path video.

The following step S35 can be performed.

S3328: determining the selected decoders are able to support the current path video.

The following step S34 can be performed.

The step S3326 can be performed before or after the step S3327, or even after the step S35, or can be performed simultaneously with the step S3327. In some embodiments, the step S3326 can be skipped, i.e. after all low priority videos are stopped and the resources are released, the estimated resource occupied percentage is still greater than the predetermined value, and playback of the low priority video (s) which were stopped will not resume.

The process of determination in this embodiment takes the priority information of the current path video into consideration, which can preferably secure playing videos with higher priority.

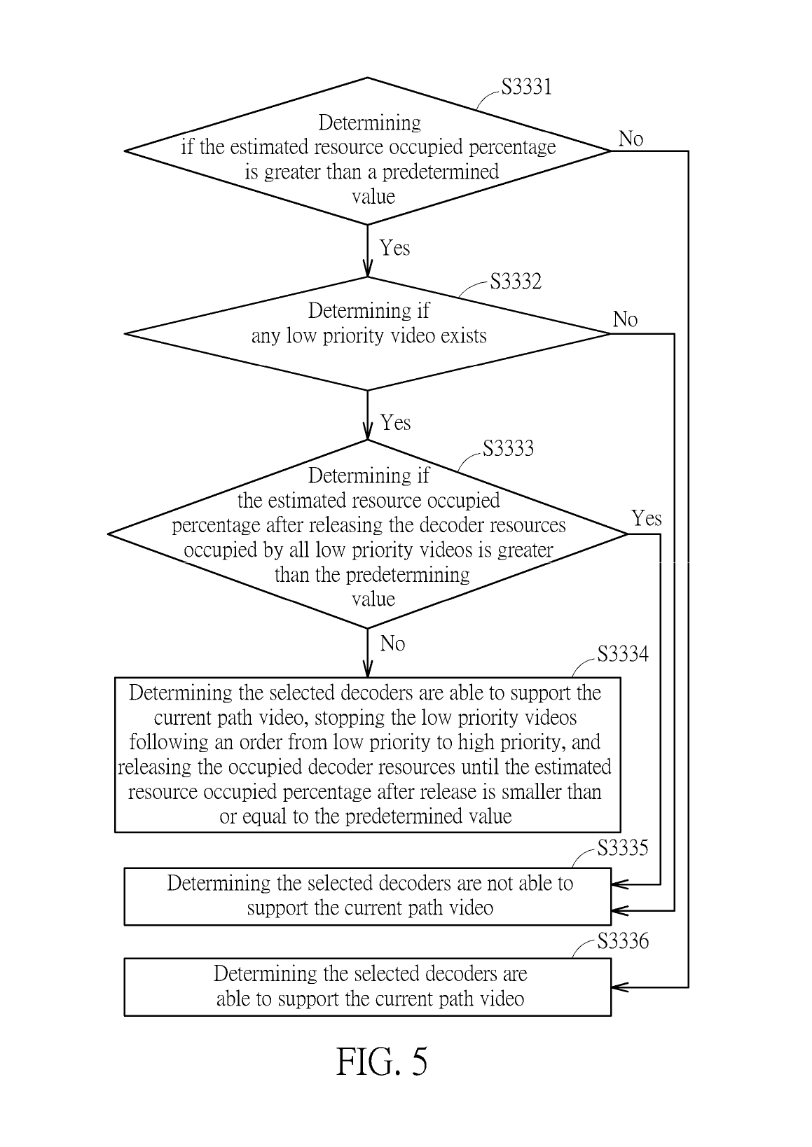

As shown in FIG. 5, a decoder resource allocating method according to a fifth embodiment of the present invention is based on the second embodiment of the present invention, wherein the step S33 specifically comprises:

S3331: determining if the estimated resource occupied percentage is greater than a predetermined value.

The predetermined value is the maximum resource occupied percentage of the selected decoders, and is a number greater than 0% and smaller than or equal to 100%. Generally speaking, the predetermined value can be 100% or a value close to 100%.

If the estimated resource occupied percentage is greater than the predetermined value, the step S3332 is entered; if not, the step S3336 is entered.

S3332: determining if any low priority video exists.

The low priority video is a video which is playing, whose priority is lower than that of the current path video, and uses the selected decoder resources.

If there are low priority videos, the step S3333 is entered; if not, the step S3335 is entered.

S3333: determining if the estimated resource occupied percentage after releasing the decoder resources occupied by all low priority videos is greater than the predetermining value.

If yes, the step S3335 is entered; if not, the step S3334 is entered.

S3334: determining the selected decoders are able to support the current path video, stopping the low priority videos following an order from low priority to high priority, and releasing the occupied decoder resources until the estimated resource occupied percentage after release is smaller than or equal to the predetermined value.

The following step S34 can be performed.

S3335: determining the selected decoders are not able to support the current path video.

The following step S35 can be performed.

S3336: determining the selected decoders are able to support the current path video.

The following step S34 can be performed.

The process of determination in this embodiment takes the priority information of the current path video into consideration, which can secure playing videos with high priority. Compared to the previous embodiment, the resource occupied percentage after stopping the low priority videos and releasing the resources is estimated predictively, and then it is determined if the percentage is greater than the predetermined value. When it is smaller than or equal to the predetermined value, this means the low priority videos are not needed to be stopped since the percentage can fulfill the requirement of the current path video. In this way, unnecessary stopping of the low priority videos can be decreased. This embodiment can be applied to the scenario of decoder resources occupied by low priority videos being known.

For example, assume decoders 0 and 1 are presented. The decoder performance parameter table is shown in Table 1.

TABLE 1

| | | | | The | |
|---|---|---|---|---|---|
| | | The | The | maximum | |
| | | maximum | maximum | FPS | |
| | | FPS | FPS | supported by | The decoder |
| | | supported by | supported by | the decoders | selecting |
| Decoding type | Resolution | the decoder 0 | the decoder 1 | 0 and 1 | method |
| H264/H265 | 4K/2K | 30 | 30 | 60 | 2 |
| H264/H265 | Full HD | 120 | 120 | 240 | 1 |
| MPEG4/WMV | Full HD | 0 | 60 | 60 | 1 |

In this embodiment, the decoder selecting method is determined by the decoding type and the resolution of videos which are listed in Table 1. Number ‘2’ means the decoders 0 and 1 are simultaneously used, number ‘1’ means the decoder 1 is preferably selected, and number ‘0’ means the decoder 0 is preferably selected.

Initially, there is no video playing, and the total resource occupied percentage of each decoder is 0.

Then, the first path video is taken as the current path video to select the suitable decoder resource. The decoding type of the first path video is H264, the resolution is 4K, and the FPS is 30, and according to the parameters of the first path video, the decoders 0 and 1 are selected based on Table 1. Therefore, the occupied resources are equally allocated to the decoders, and the estimated resource occupied percentage of each decoder is 0%+30/(2*30)*100%=50%. As this is smaller than the predetermined value 100%, the first path video can be played. In this time, the total resource occupied percentage of each of the decoders 0 and 1 is 50%.

Then, the second path video is taken as the current path video to select the suitable decoder resource. The decoding type of the second path video is MPEG4, the resolution is Full HD (i.e. 1920*1080), and the FPS is 30, and according to the parameters of the second path video, only the decoder 1 is selected based on Table 1. The estimated resource occupied percentage of the decoder 1 is 50%+30/60*100%=100% which equals the predetermined value 100%. The second path video can thus be played. In this time, the total resource occupied percentage of the decoder 0 is 50% while that of the decoder 1 is 100%.

Then, the third path video is taken as the current path video to select the suitable decoder resource. The decoding type of the third path video is H265, the resolution is Full HD, and the FPS is 30, and according to the parameters of the third path video, only the decoder 1 is selected based on Table 1. The total resource occupied percentage of decoder 1 reaches the predetermined value 100%, however, which means it is not able to support playing the third path video. The decoder 0 is selected instead. The estimated resource occupied percentage of the decoder 0 is 50%+30/120*100%=75% which is smaller than the predetermined value 100%. The third path video can thus be played. In this time, the total resource occupied percentage of the decoder 0 is 75% while that of the decoder 1 is 100%.

Then the fourth path video is taken as the current path video to select the suitable decoder resource. The decoding type of the third path video is H.265, the resolution is Full HD, and the FPS is 36, and according to the parameters of the fourth path video, only the decoder 1 is selected based on Table 1. The total resource occupied percentage of decoder 1 reaches the predetermined value 100%, however, which means it is not able to support playing the fourth path video. The decoder 0 is selected instead. The estimated resource occupied percentage of the decoder 0 is 75%+36/120*100%=75%+30%=105% which is greater than the predetermined value 100%. In this case, the fourth path video cannot be played when the video has no priority, when the priority of the video is not considered, or when the priority of the video is considered but there is no low priority video. On the other hand, if there is low priority video, for example, the third path video whose priority is lower than that of the fourth path video, the third path video is stopped and the resource is released. The estimated resource occupied percentage of the decoder 0 is 50%+30%=80% which is smaller than the predetermined value 100%. In this way, the fourth path video is played after the third path video is stopped to secure the play of the fourth path video whose priority is higher.

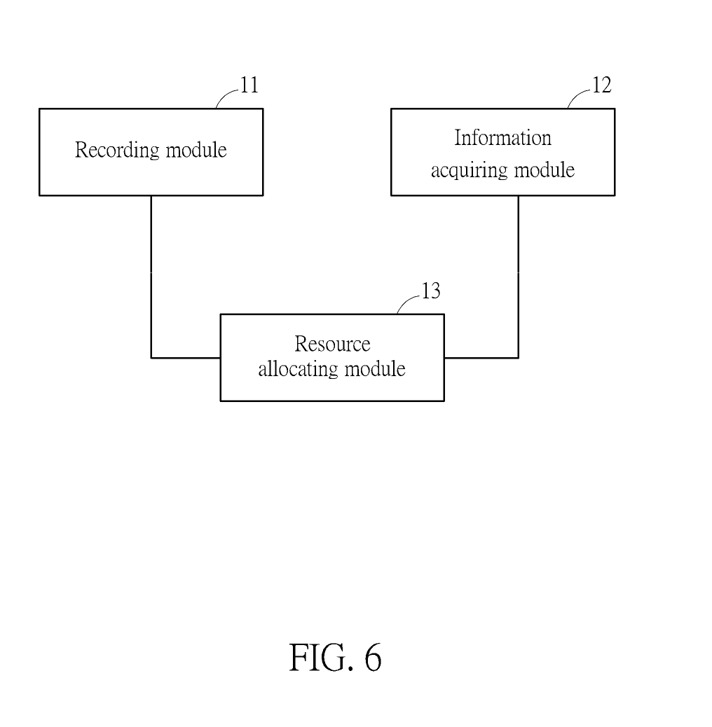

As shown in FIG. 6, a decoder resource allocating apparatus according to a first embodiment of the present invention comprises: a recording module 11, arranged to record a total resource occupied percentage of each decoder occupied by videos which are playing. The apparatus further comprises an information acquiring module 12, arranged to acquire a decoder selecting method, a decoding type, and a required decoder resource of a current path video, and a resource allocating module 13, arranged to look up a decoder performance parameter table according to the total resource occupied percentage of each decoder, the decoder selecting method, the decoding type and the required decoder resource to select a suitable decoder resource.

Alternatively, the decoder selecting method comprises at least one of a number of the decoders simultaneously being used and the priority information of the decoders being used.

Alternatively, the decoder performance parameter table lists the maximum FPS supported by different decoding types and different resolutions under different decoder selecting methods according to the decoding ability of each decoder.

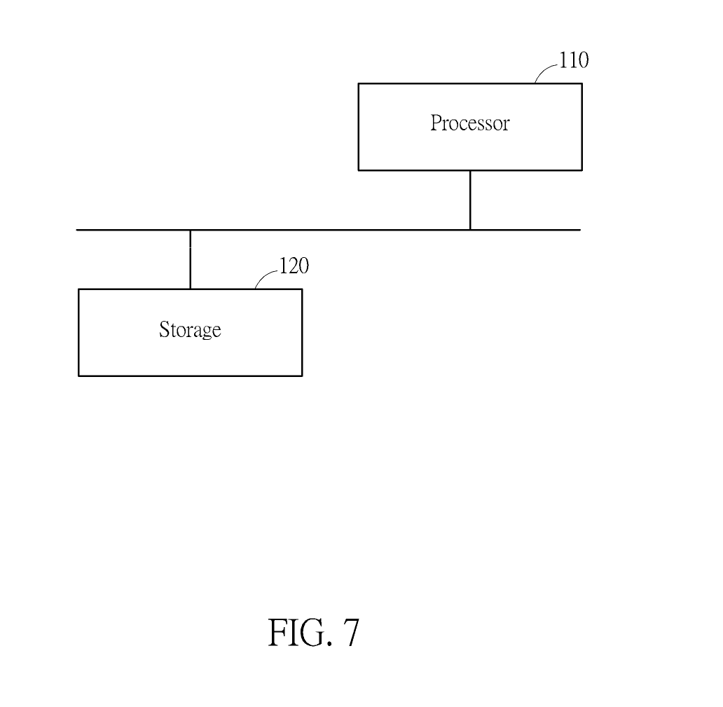

As shown in FIG. 7, a decoder resource allocating apparatus according to a second embodiment of the present invention comprises: a processor 110 and a storage 120.

The processor 110 controls the operation of the decoder resource allocating apparatus, and the processor 110 can also be a central Processing Unit (CPU). The processor 110 can be an integrated circuit (IC) chip which has a signal processing ability. The processor 110 can also be a general processor, a digital signal processor (DSP), an Application-specific integrated circuit (ASIC), a Field Programmable Gate Array (FPGA) or other programmable logic elements, a separate gate or a transistor logic device, wherein the general processor can be a microprocessor or any regular processor.

The storage 120 is arranged to store commands and data necessary for the operation of the processor 110, the total resource occupied percentage of each decoder, the decoder performance parameter table, etc.

The processor 110 is arranged to record the total resource occupied percentage of each decoder occupied by videos which are playing; acquire the decoder selecting method, the decoding type and the required decoder resource of the current path video; and look up the decoder performance parameter according to the total resource occupied percentage of each decoder, the decoder selecting method, the decoding type and the required decoder resource to select a suitable decoder.

Alternatively, the decoder selecting method comprises at least one of a number of the decoders simultaneously being used and the priority information of said the decoders being used.

Alternatively, the decoder performance parameter table lists the maximum FPS supported by different decoding types and different resolutions under different decoder selecting methods according to the decoding ability of each decoder.

Alternatively, the processor selects a decoder from candidate decoders according to the decoding type and the decoder selecting method; determines an estimated resource occupied percentage of the selected decoders according to the total resource occupied percentage of the selected decoders and the decoder resources required for playing the current path video, wherein the estimated resource occupied percentage is the sum of the total resource occupied percentage of the selected decoders and the percentage of the decoder resource required for playing the current path video over the total resource of the selected decoders; determines if the selected decoders are able to support the current path video according to the estimated resource occupied percentage; if yes, uses the selected decoders to play the current path video and update the total resource occupied percentage of the selected decoder; and if not, removes the select decoders from the candidate decoder without using the selected decoder to play the current path video to update the candidate decoders. The abovementioned steps are iteratively performed.

Alternatively, the processor 110 is arranged to determine if the estimated resource occupied percentage is greater than a predetermined value; if the estimated resource occupied percentage is greater than the predetermined value, it determines that the selected decoders are not able to support the current path video; and if the estimated resource occupied percentage is smaller than or equal to the predetermined value, it is determined that the selected decoders are able to support the current path video.

Alternatively, the processor 110 is arranged to determine if the estimated resource occupied percentage is greater than the predetermined value; if the estimated resource occupied percentage is smaller than or equal to the predetermined value, it is determined that the selected decoders are able to support the current path video; if the estimated resource occupied percentage is greater than the predetermined value, it is determined if there is any low priority video; if not, it is determined that the selected decoders are not able to support the current path video; if yes, the low priority videos are stopped following an order from low priority to high priority and the occupied decoder resources are released, and it is determined if the estimated resource occupied percentage after release is smaller than or equal to the predetermined value; if yes, it is determined that the selected decoders are able to support the current path video; if not, the low priority videos continue to be stopped and the resources continue to be released; if all the low priority videos are stopped and the estimated resource occupied percentage after releasing resource is greater than the predetermined value, it is determined that the selected decoders are not able to support the current path video.

Alternatively, after all the low priority videos are stopped and the estimated resource occupied percentage is greater than the predetermined value, the processor 110 is further arranged to resume playing the low priority videos which have been stopped.

Alternatively, the processor 110 is arranged to determine if the estimated resource occupied percentage is greater than the predetermined value; if the estimated resource occupied percentage is smaller than or equal to the predetermined value, it is determined that the selected decoders are able to support the current path video; if the estimated resource occupied percentage is greater than the predetermined value, it is determined if there are any low priority videos; if not, it is determined that the selected decoders are not able to support the current path video; if yes, it is determined if the estimated resource occupied percentage is greater than the predetermined value after releasing the decoder resources occupied by all the low priority videos; if yes, it is determined that the selected decoders are not able to support the current path video; if not, it is determined the selected decoders are able to support the current path video, and the low priority videos are stopped following an order from low priority to high priority and the occupied decoder resources are released until the estimated resource occupied percentage after release is smaller than or equal to the predetermined value.

The functions of each part of the decoder resource allocating apparatus in the embodiments of the present invention can be known by referring to the description in the corresponding decoder resource allocating method. The details are therefore omitted here.

It should be noted that the disclosed apparatuses and methods in some embodiments of the present invention can be implemented in other ways. For example, the abovementioned apparatus are only exemplary. Said modules or units are only divided based on the functions. In the actual design, they can be divided differently, however. For example, multiple units or elements can be combined or integrated into another system, or some features can be omitted, or not executed. Alternatively, displayed coupling or directly coupling through a communication connection can be made through connectors. Indirect coupling between apparatuses or units or the communication connections can be electrical connections, mechanical connections, or in other forms.

Those units mentioned as the separate parts can be optionally physically separated. Those parts displayed as units can optionally be physical units, i.e. can be positioned within one location, or be distributed to a plurality of network units. A part or all of the units can be selected to implement the scheme of the present invention based on the actual design.

In addition, the functional units in the embodiments of the present invention can be integrated as a processing unit, physically exist as a single unit, or two or more units can be integrated as one unit. Said integrated units can be implemented in hardware or software.

When said integrated units are implemented in software and sold or used as an independent product, the units can be stored in a computer readable storage medium. Accordingly, a part or all of the schemes or only the parts of the schemes making contributions on the prior art can be shown in software. The computer software product is stored in a storage medium, comprising a plurality of commands to make a computer device (which can be a personal computer, a server, or internet device, etc.) or a processor executing a part or all of the steps of the methods disclosed by the present invention. The abovementioned storage medium comprises: a USB drive, an external hard drive, a Read-Only Memory (ROM), a Random Access Memory (RAM), a disc, or a CD, etc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A decoder resource allocating method, comprising:
recording a total resource occupied percentage of each decoder occupied by videos which are playing;
acquiring a decoder selecting method, a decoding type, and a required decoder resource of a current path video; and
looking up a decoder performance parameter table according to the total resource occupied percentage of each decoder, the decoder selecting method, the decoding type, and the required decoder resource to select a suitable decoder resource.

2. The decoder resource allocating method of claim 1, wherein the decoder selecting method comprises at least one of a number of decoders simultaneously being used and priority information of the decoders being used.

3. The decoder resource allocating method of claim 1, wherein the decoder performance parameter table comprises maximum frames per second (FPS) supported by different decoding types and different resolutions under different decoder selecting methods, wherein the different decoding types and the different resolutions are obtained according to the ability of each decoder.

4. The decoder resource allocating method of claim 1, wherein the step of looking up the decoder performance parameter table according to the total resource occupied percentage of each decoder, the decoder selecting method, the decoding type, and the required decoder resource to select the suitable decoder resource comprises:
selecting decoders from candidate decoders according to the decoding type and the decoder selecting method;
calculating estimated resource occupied percentage for the selected decoders according to the total resource occupied percentage of the selected decoders and the decoder resources required for playing the current path video, in which the estimated resource occupied percentage is a sum of the total resource occupied percentage of the selected decoders and the percentage of the decoder resources required for playing the current path video over the total resource percentage of the selected decoders;
determining if the selected decoders are able to support the current path video according to the estimated resource occupied percentage;
if the selected decoders are able to support the current path video, using the selected decoders to play the current path video and updating the total resource occupied percentage of the selected decoder; and
if the selected decoders are not able to support the current path video, removing the selected decoders from the candidate decoders without using the selected decoder to play the current path video to update the candidate decoders;
wherein the abovementioned steps are iteratively performed.

5. The decoder resource allocating method of claim 4, wherein the step of determining if the selected decoders are able to support the current path video according to the estimated resource occupied percentage comprises:
determining if the estimated resource occupied percentage is greater than a predetermined value;
if the estimated resource occupied percentage is greater than the predetermined value, determining the selected decoders are not able to support the current path video; and
if the estimated resource occupied percentage is smaller than or equal to the predetermined value, determining the selected decoders are able to support the current path video.

6. The decoder resource allocating method of claim 4, wherein the step of determining if the selected decoders are able to support the current path video according to the estimated resource occupied percentage comprises:
determining if the estimated resource occupied percentage is greater than a predetermined value;
if the estimated resource occupied percentage is smaller than or equal to the predetermined value, determining the selected decoders are able to support the current path video; and
if the estimated resource occupied percentage is greater than the predetermined value, determining if there is any low priority videos; if not, determining the selected decoders are not able to support the current path video; if yes, sequentially stopping the low priority videos following an order from low priority to high priority and releasing the occupied decoder resource; and determining if the estimated resource occupied percentage after release is smaller than or equal to the predetermined value; if yes, determining the selected decoders are able to support the current path video; if not, keeping stopping the low priority videos sequentially following the order from low priority to high priority and releasing the resource, and determining the selected decoders are not able to support the current path video when all the low priority videos are stopped and the estimated resource occupied percentage after release is greater than the predetermined value.

7. The decoder resource allocating method of claim 6, wherein the step of determining if the selected decoders are able to support the current path video according to the estimated resource occupied percentage comprises:
resuming playing the low priority videos.

8. The decoder resource allocating method of claim 4, wherein the step of determining if the selected decoders are able to support the current path video according to the estimated resource occupied percentage comprises:
determining if the estimated resource occupied percentage is greater than a predetermined value; and
if the estimated resource occupied percentage is smaller than or equal to the predetermined value, determining the selected decoders are able to support the current path video; if the estimated resource occupied percentage is greater than the predetermined value, determining if there is any low priority video; if not, determining the selected decoders are not able to support the current path video; if yes, releasing the decoder resources occupied by the low priority videos and determining if the estimated resource occupied percentage after release is greater than the predetermined percentage; if yes, determining the selected decoders are not able to support the current path video; if not, determining the selected decoders are able to support the current path video, and sequentially stopping the low priority videos following an order from low priority to high priority and releasing the occupied decoder resources until the estimated resource occupied percentage after release is smaller than or equal to the predetermined value.

9. A decoder resource allocating apparatus, comprising:
a recording module, arranged to record a total resource occupied percentage of each decoder occupied by videos which are playing;
an information acquiring module, arranged to acquire a decoder selecting method, a decoding type, and a required decoder resource of a current path video; and
a resource allocating module, arranged to look into a decoder performance parameter table according to the total resource occupied percentage of each decoder, the decoder selecting method, the decoding type, and the required decoder resource to select a suitable decoder resource.

10. The decoder resource allocating apparatus of claim 9, wherein the decoder selecting method comprises at least one of a number of decoders simultaneously being used and priority information of the decoders being used.

11. The decoder resource allocating apparatus of claim 9, wherein the decoder performance parameter table lists maximum frame rates supported by different decoding types and different resolutions under different decoder selecting methods according to the decoding ability of each decoder.
